(19) United States
(12) Patent Application Publication
(10) Pub. No.: US 2022/0207493 A1
(43) Pub. Date: Jun. 30, 2022

(54) A SYSTEM AND METHOD FOR ESTIMATION OF MALFUNCTION IN THE HEAVY EQUIPMENT

(71) Applicant: BORUSAN MAKINA VE GUC SISTEMLERI SANAYI VE TICARET ANONIM SIRKETI, Istanbul (TR)

(72) Inventor: Salih SERTBAS, Kocaeli (TR)

(73) Assignee: BORUSAN MAKINA VE GUC SISTEMLERI SANAYI VE TICARET ANONIM SIRKETI, Istanbul (TR)

(21) Appl. No.: 17/605,833

(22) PCT Filed: Apr. 22, 2020
(86) PCT No.: PCT/TR2020/050343

§ 371 Date: Oct. 22, 2021

(30) Foreign Application Priority Data
Apr. 24, 2019 (TR) 2019/06067

(51) Int. Cl. G06Q 10/00; G05B 23/02; G06Q 50/08

(52) U.S. Cl. CPC G06Q 10/20; G06Q 50/08; G05B 23/0283

(57) ABSTRACT

The present invention, relates to an online malfunction estimation method that allows taking required precautions for possible malfunctions to be detected in the heavy equipment. More specifically, the present invention relates to a method that allows estimating of maintenance by processing of provided data related to construction machines, such as type, model, working hours, working conditions, maintenance history, obtained through a mobile application running on a mobile device and a platform miming on a computing device as well as processing of sensor data received through a data transfer device, by machine learning methods, and that allows development of data analytics infrastructure.

### TECHNICAL FIELD

The present invention relates to a system and method for the estimation of malfunctions in long periods by processing the old service records of the customer equipment and the physical data obtained instantly by machine learning methods, and thus sharing them with the relevant business units.

More specifically, the present invention relates to a method that allows estimating of maintenance by processing of provided data related to construction machines, such as type, model, working hours, working conditions, maintenance history, obtained through a mobile application running on a mobile device and a platform running on a computing device as well as processing of sensor data received through a data transfer device, by machine learning methods, and that allows development of data analytics infrastructure.

More specifically, the present invention relates to an online malfunction estimation method that allows taking required precautions for possible malfunctions to be detected in the heavy equipment.

### PRIOR ART

With the development of technology, the place of machines in our lives is increasing day by day. The machines, which are located in many areas, are taken to the service periodically and thus, the necessary maintenance and controls are performed and the malfunctions are eliminated. The maintenance performed prolongs the life of the machines. It is very important in terms of labor, time and cost to ensure that the malfunctions in the machines are fixed and functioning properly.

Like every working machine, heavy equipment sometimes fail and need repair. Unlike the machines produced for end users, the repair processes of the heavy equipment prevent the operation of the machinery, causing the work to be impossible and the work plan to be troubled. In this regard, pre-detection of malfunctions that may occur in heavy equipment will ensure the problems to be solved before they become more critical.

The maintenance operations that can be done before the machine becomes useless will minimize the downtime of the machine and prevent the operator's job losses. At the same time, when possible problems are predicted before they reach the chronic stage, repair and maintenance operations will be performed faster and their costs will decrease. For this reason, many systems have been developed that estimate downtime and frequency. These systems usually estimate the failure of a single machine. It is not possible to dynamically receive data on a large number of heavy equipments. Another problem is the unconditional malfunction detection in these systems according to the predefined procedures. For example, when the oil sensor of the machine lights, this condition is considered correct and its oil is changed. The possibility of a sensor malfunction is ignored. Current estimating systems cannot specifically predict which parts will fail. In addition, it is not possible to determine the failure rate for a long period such as a month later. The repair costs are high due to the high costs of repairs and the failure of the machines during the repair to the operator, both in terms of time and economy. When the system ensures that this loss is minimized; minimizing repair costs of operators will provide an advantage both economically and in time.

This situation made it necessary to develop a method that will predict possible problems by evaluating the parameters such as usage statistics in the customer portfolio, general usage statistics specific to the machine model and working conditions related to the machines used by the customers.

The document DE10235525 mentions a method for monitoring the condition of a motor vehicle. For this reason, data mining technologies and machine learning methods are used. However, it is not mentioned here about a method that allows the old service records of the customer equipment and the physical data obtained instantly to be processed by machine learning methods, to predict the failure in long periods and thus to share them with the relevant business units.

The document US20110172973 mentions to a method for analyzing equipment malfunctions and maintenance schedules. An equipment maintenance system constitutes an equipment model and components of each piece of equipment. The equipment maintenance system can detect estimated failure information for each component based on a selected statistical model, and can also create a maintenance schedule based on the estimated failure information determined for each component of the equipment. However, here it is not possible to obtain data from the sensors for a large number of equipment at the same time, quickly and practically, and to predict specific parts of the equipment by means of machine learning methods based on the old service records.

The document U.S. Pat. No. 7,218,974 mentions a method for optimizing an industrial process data. It is mentioned that each sensor element receives data from a part of the industrial process and verification of the received data is required by more than one sensor element. Therefore, It is not mentioned that in addition to data such as type, model, working hours, working conditions, maintenance history related to the heavy equipments received through a mobile application running on a mobile device, the sensor data received with a data transfer device is not processed by machine learning methods, and no maintenance estimation is made and the data analytics infrastructure is not developed.

Consequently, the need for estimation of malfunctions in long periods and sharing of them with relevant business units by dynamically processing the old service records and instant physical data of many heavy equipments with machine learning methods required the emergence of the solution according to the present invention.

### OBJECTIVES AND SHORT DESCRIPTION OF THE INVENTION

The aim of the present invention is to introduce a system and method that allow for the estimation of malfunctions by processing the old service records of the customer equipment and the physical data received instantly by machine learning methods, and thus sharing with the relevant business units.

Another aim of the invention is to reveal a method that allows estimating of maintenance by processing of provided data related to construction machines, such as type, model, working hours, working conditions, maintenance history, obtained through a mobile application running on a mobile device as well as processing of sensor data received through a data transfer device, by machine learning methods, and that allows development of data analytics infrastructure.

Another aim of the invention is to provide an online malfunction estimation method that allow the possible measures to be taken by identifying potential failures in the heavy equipment.

One another aim of the invention is to present a system and method that allow practical and quick malfunction estimation by dynamically obtaining physical data from the sensors for many heavy equipment.

The other aim of the invention is to present a method that allow failure estimation in long periods such as one month and after.

Another aim of the invention is to replace the spare parts by obtaining the spare part of the heavy equipment before it fails, and thus to prevent the disruption in the work plan.

One other aim of the invention is to take the necessary precautions by ensuring that the data regarding the fault estimates are automatically shared with the customer or sales team through an ERP system.

Another aim of the invention is to minimize the downtime of the machines and reducing the inventory costs by making the failure estimation on the basis of parts.

In order to achieve the above aims, the present invention reveals a malfunction estimation system by processing data of customer equipment using machine learning methods and it comprises
at least one mobile device which includes a mobile application that allows information entry of equipment and allows monitoring the status of the equipment,
at least one data processing device which includes an internet platform that allows information entry of the equipment and allows monitoring the status of the equipment,
at least one sensor on the equipment,
at least one data transfer device that allows data to be received from sensors via GSM and satellite infrastructure,
an ERP system that allows the storage and processing of various data,
a data warehouse that allows data exchange between different environments,
at least one server that allows the development of estimation algorithms using machine learning methods,
a learning component and an estimating component that allow continuous improvement of said server,
at least one test platform that allows the results of estimation algorithms to be measured according to the criteria predetermined by the business units,
at least one cloud server that allows analysis of estimate data.

The malfunction estimation system also comprises
transferring the data processed in the learning component within the server to the estimation component at certain times,
the estimation component being instantly integrated with the ERP system.

The invention is a method that enables the failure estimation by processing the data related to the customer equipment by machine learning methods and comprises the following process steps:
recording data of the equipment in the ERP system through an internet platform running on a mobile application and data processing devices installed on mobile devices,
sending data, received from the sensors on the equipment via GSM and satellite technologies via a data transfer device, for storing in the ERP system via a data warehouse,
in the ERP system, bringing the mentioned data to the suitable format for modeling by using statistical data conversion methods with detailed analysis results,
integration of ERP system with the server where machine learning algorithms will be developed,
sending data in the suitable format for modeling within the ERP system to the server through the data warehouse,
estimating possible failures by using machine learning methods for data related to equipment coming from ERP system in the server,
measuring the results of the algorithms used on the test platform according to the performance criteria to be determined in advance with the business units,
sending the estimate data of the equipment from the server to the ERP system via the data warehouse,
estimating data is sent to the cloud server by means of a data warehouse from the ERP system and the analysis data of the estimates are performed,
sending the estimate data to the mobile device and the data processing device via a data warehouse,
sharing the estimating data with the relevant units through the application on the mobile device and internet platform in the data processing devices.

In the method of the invention; while the learning process is performed from the errors itself in the learning component, estimation component transfers to the ERP system with the data warehouse by providing the data to be processed instantly and conducting continuous improvement processes.

In another embodiment of the method according to the invention; it is possible to receive data from the sensors of a large number of customer equipment by using Internet of Things (IOT) technologies, by adding GPS data to the received data, sending it to the ERP system servers of the relevant institution over the TCP protocol via the GSM network, and sending the said data to consumer applications via a message distributor application.

In the method of the invention; the physical data coming from the sensors, by using the service recording process of the equipment from past periods, malfunction estimation is performed with machine learning methods.

### DESCRIPTION OF THE FIGURES

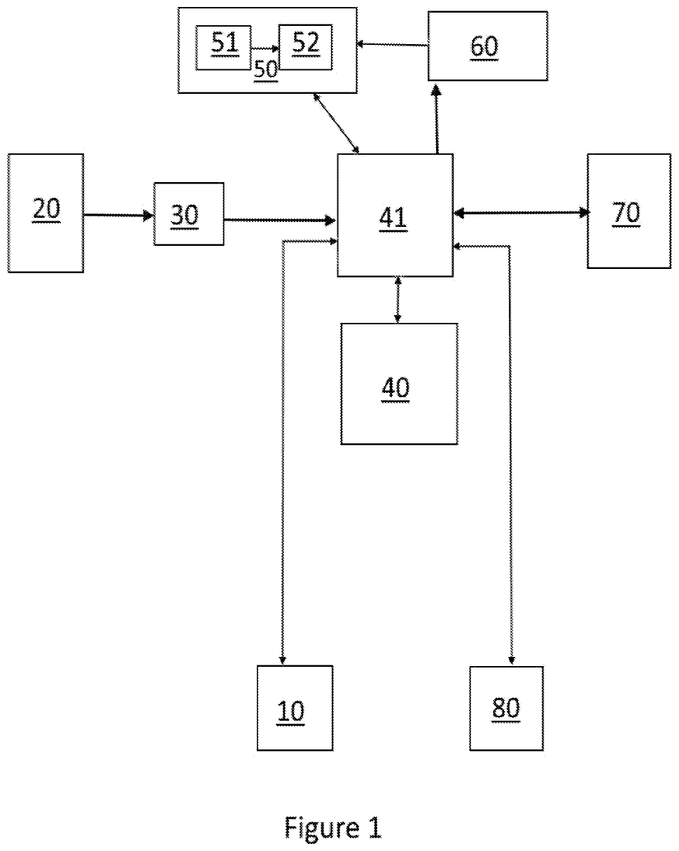

In FIG. 1, system components of the method subject to the invention and interaction between them are shown.

### REFERENCE NUMBERS

10. Mobile Device
20. Sensor
30. Data Transfer Device
40. ERP System
41. Data warehouse
50. Server
51. Learning Component
52. Estimation Component
60. Test Platform
70. Cloud Server
80. Data processing device

### DETAILED DESCRIPTION OF THE INVENTION

The present invention relates to a system and method that allow the old service records of the customer equipment and the physical data obtained instantly to be processed by machine learning methods, allowing for the estimation of malfunctions in long periods and thus sharing them with the relevant business units.

In the present invention, besides data such as type, model, working hours, working conditions, maintenance history, as well as data transfer related to the heavy equipment received through a mobile application operating on the mobile device (10) and an internet platform operating on the data processing device (80). Maintenance data is estimated and the data analytics infrastructure is developed by processing the data of the sensor (20) received via the device (30) in a server (50) by machine learning methods. Within the learning component (51) of the said server (50), the data is processed daily. Data processing is performed instantly within the estimation component (52).

System components in which the present innovative method is applied and interaction between them are shown in FIG. 1. The mentioned system mainly has at least one data processing device (80) containing at least one mobile device (10) with a mobile application and an internet platform where customers can enter information about their machine fleets and track the status of their machines, at least one sensor (20) on the machines, at least one data transfer device (30) that allows the acquisition of data from the sensors (20) by GSM and satellite infrastructure, an ERP system (40) where various data are stored and processed, a data warehouse (41) that allows data exchange between different environments, at least one server (50) that enables the development of estimating algorithms using machine learning methods (51), learning about said server component (51) and estimating component (52), at least one test platform (60) that allows the results of the estimating algorithms to be measured according to the criteria predetermined by the business units, at least one cloud server (70) that allows the analysis of the estimating data.

With the method of the invention, instant data is obtained from tens of thousands of heavy equipment. In order to obtain data from the sensors (20), data transfer devices (30) are placed on the heavy equipments. In this way, instant information can be obtained from sensors (20) online using GSM and satellite technologies and Internet of Things (IOT-Internet of Things). GPS data is also added to the received data and sent to the ERP system (40) servers of the relevant institution over the TCP (Transmission Control Protocol) protocol via GSM/GPRS. This data is then sent to consumer applications such as complex event processing, IoT database via a message broker application.

As an example of the method, its application on heavy equipment is described, but it is not restrictive, but it can also be applied to other machinery and equipment. Effective estimation is performed in an existing machine pool. When applied to any machine pool, it will be able to offer the same function if there is sufficient historical machine data. The system to be developed on the basis of heavy equipment has the potential to be applied to other types of machinery.

In the present invention, firstly, the customers provide data for their heavy equipment to be recorded in the ERP system (40) by means of an internet platform running on a mobile application and data processing device (80) installed on mobile devices (10). In addition to receiving up-to-date data from customers with the developed mobile application and internet platform, customers are also informed about their machines. The machines in question form a large fleet of up to tens of thousands. There are various sensors (20) on the machines about the current status of the machines. Data received from said sensors (20) by means of a data transfer device (30) through GSM and satellite technologies are sent to the ERP system (40) via a data warehouse (41) for storage. In the ERP system (40), the data in question is continuously made suitable for modeling with statistical data conversion methods. Various statistical data conversion methods such as clustering, aggregation, summary extraction, transposition and mapping are used. ERP system (40) has integration with the servers (50) where the R programming language will be developed. ERP system (40) and server (50) operate in parallel. The data in the ERP system (40) is converted to the format ready for modeling and sent to the server (50) through the data warehouse (41). At the mentioned servers (50), possible errors are estimated by using machine learning methods on the data about the machines coming from the ERP system (40). In order to be a self-learning system, double algorithms are used. While one of the algorithms perform the learning process from the errors in the learning component (51), the other transfers to the ERP system (40) with the data warehouse (41) by providing the data to be processed instantly in the estimation component (52). The data processed in the learning component (51) is transferred to the estimation component (52) at certain times. The estimation component (52) is instantly integrated with the ERP system (40). Required algorithms are written in R programming language. Gradient Boosting algorithm is used as an algorithm. AUC (Area Under the Curve) statistic is applied as a measure of success. The results of the algorithms used are measured on the test platform (60) according to the performance criteria to be determined previously with the business units. The success criterion has been determined as 70% according to AUC statistics. When necessary, new data sources are scanned and the algorithm development process is updated. In this way, continuous improvement studies are made. Estimation data for the machines come from the server (50) to the ERP system (40) via the data warehouse (41). From there, the estimate data is sent to the cloud server (70) to be analyzed. At the same time, the estimation data received from the ERP system (40) through the data warehouse (41) are shared with the relevant units through the application run on the mobile devices (10) of the customers and internet platform in the data processing device (80).

With the present invention, the possible malfunctions of the heavy equipment can be predicted in advance and spare parts can be ordered before the machine parts fail, and the necessary maintenance will be done and the malfunction will be eliminated by taking precautions. By predicting the malfunctions beforehand, the chance of intervention will occur before it becomes chronic and thus the life of the machines will be extended, and the non-operating times of the machine can be minimized.

The machine information obtained from the customers and the data coming from the sensors (20) on the machines are processed instantly with machine learning algorithms and the fault is estimated and reflected to the business unit and customers as a value. Unlike other methods, both the sensor (20) data and the historical service data are used in the said method. In this way, no recitative estimation is made based on predefined procedures.

Using the historical data, the signals received from the machines and the information of the equipment and how they are served against these signals are examined. With these inputs and outputs, a system has been developed where the machines can be guessed without malfunction. Estimation success achieved by the method of the invention is 85%.

1. A malfunction estimation system by processing data of customer equipment using machine learning methods characterized in that it comprises
at least one mobile device (10) which includes a mobile application that allows information entry of equipment and allows monitoring the status of the equipment,
at least one data processing device (80) which includes an internet platform that allows information entry of the equipment and allows monitoring the status of the equipment,
at least one sensor (20) on the equipment,
at least one data transfer device (30) that allows data to be received from sensors (20) via GSM and satellite infrastructure,
an ERP system (40) that allows the storage and processing of various data,
a data warehouse (41) that allows data exchange between different environments,
at least one server (50) that allows the development of estimation algorithms using machine learning methods,
a learning component (51) and an estimating component (52) that allow continuous improvement of said server (50),
at least one test platform (60) that allows the results of estimation algorithms to be measured according to the criteria predetermined by the business units,
at least one cloud server (70) that allows analysis of estimate data.

2. A malfunction estimation system according to claim 1 characterized in that it comprises
transferring the data processed in the learning component (51) within the server (50) to the estimation component (52) at certain times,
the estimation component (52) being instantly integrated with the ERP system (40).

3. A method of malfunction estimation by processing data related with customer equipment by machine learning methods characterized in that it comprises
recording data of the equipment in the ERP system (40) through an internet platform running on a mobile application and data processing devices (80) installed on mobile devices (10),
sending data, received from the sensors (20) on the equipment via GSM and satellite technologies via a data transfer device (30), for storing in the ERP system (40) via a data warehouse (41),
in the ERP system (40), bringing the mentioned data to the suitable format for modeling by using statistical data conversion methods with detailed analysis results,
integration of ERP system (40) with the server (50) where machine learning algorithms will be developed,
sending data in the suitable format for modeling within the ERP system (40) to the server (50) through the data warehouse (41),
estimating possible failures by using machine learning methods for data related to equipment coming from ERP system (40) in the server (50),
measuring the results of the algorithms used on the test platform (60) according to the performance criteria to be determined in advance with the business units,
sending the estimate data of the equipment from the server (50) to the ERP system (40) via the data warehouse (41),
estimating data is sent to the cloud server (70) by means of a data warehouse (41) from the ERP system (40) and the analysis data of the estimates are performed,
sending the estimate data to the mobile device (10) and the data processing device (80) via a data warehouse (41),
sharing the estimating data with the relevant units through the application on the mobile device (10) and internet platform in the data processing devices (80).

4. A method of malfunction estimation according to claim 3 characterized in that while the learning process is performed from the errors itself in the learning component (51), estimation component (52) transfers to the ERP system (40) with the data warehouse (41) by providing the data to be processed instantly and conducting continuous improvement processes.

5. A method of malfunction estimation according to claim 3 characterized in that it comprises receiving online data from the sensors (20) of a large number of customer equipment by using Internet of Things (IOT) technologies, by adding GPS data to the received data, sending it to the ERP system (40) servers of the relevant institution over the TCP protocol via the GSM network, and sending the said data to consumer applications via a message distributor application.

6. A method of malfunction estimation according to claim 3 characterized in that in addition to the physical data coming from the sensors (20), by using the service recording process of the equipment from past periods, malfunction estimation is performed with machine learning methods.
